(19) United States
(12) Patent Application Publication
(10) Pub. No.: US 2002/0182300 A1
(43) Pub. Date: Dec. 5, 2002

(54) Process for the preparation of a frozen confection

(75) Inventors: Bjorn F. Groh, Munich (DE); Christiaan Bisperink, Herpen (NL)

Correspondence Address: WINSTON & STRAWN, PATENT DEPARTMENT, 1400 L STREET, N.W., WASHINGTON, DC, 20005-3502, US

(73) Assignee: Nestec S.A.

(21) Appl. No.: 10/098,343

(22) Filed: Mar. 18, 2002

Related U.S. Application Data
(63) Continuation of application No. PCT/EP00/09117, filed on Sep. 15, 2000.

(30) Foreign Application Priority Data
Sep. 18, 1999 (EP) 99118488.8

(51) Int. Cl. A23G 9/00

(52) U.S. Cl. 426/566

(57) ABSTRACT

The invention relates to a process for the preparation of a fat-containing, foamed, frozen confection. The process includes mixing ingredients of a fat-containing confection together, pasteurizing and homogenizing the mixture, and cooling the homogenized mixture in at least two steps. During the first cooling step, the homogenized mixture is cooled from the homogenization or pasteurization temperature to about 10° C. to 35° C. For the second step, the mixture is further cooled to about 1° C. to 10° C. Between the cooling steps, the mixture is held at a temperature of 10° C. to 35° C. After the cooling steps, the cooled mixture is then maintained at a temperature of about 1° C. to 10° C. for at least 0.1 hour, and then the process includes freezing the cooled mixture and incorporating air or another gas into the mixture prior to or simultaneously with the freezing to form the frozen confection.

### CROSS-REFERENCE TO RELATED APPLICATION

This application is a continuation of the U.S. national stage designation of International application no. PCT/EP00/09117, filed Sep. 15, 2000, the contents of which are expressly incorporated herein by reference thereto.

### FIELD OF INVENTION

The present invention concerns a process for the preparation of a fat-containing, foamed, frozen confection and to the confection that is produced by the process.

### BACKGROUND OF THE INVENTION

It is known in the art that for the preparation of a fat-containing, foamed, frozen confection, such as ice cream, it is necessary before proceeding with the freezing and with the hardening of the ice cream to carry out a maturation. This maturation, also called aging, is a period wherein the mixture of ingredients after blending, homogenization, and pasteurization (not necessarily in that order) is maintained for several hours at a temperature around some degrees above the freezing point of the mixture.

Preferred ingredients of the fat-containing, foamed, frozen confection include water, fruit juices, milk, dairy, or vegetable fat, milk derivatives, or vegetable protein, carbohydrates including sugars, stabilizers, and emulsifiers, and mixtures thereof. The confection may contain flavoring or coloring ingredients. Sources of fats are dairy fat or vegetable fat, preferably hydrogenated palm, palm kernel, coconut, and other fats are used. The stabilizer includes one or more of gelatin or polysaccharides such as starch, carrageenan, sodium alginate, sodium carboxymethyl-cellulose, guar gum, locust bean gum, pectin, and similar proteins and polysaccharides. Emulsifiers include one or more of mono- and diacyl glycerides of fatty acids, polyoxyethylene sorbitan ester of fatty acids, lecithin, polyglycerol ester, mono- and di-saccharid ester of fatty ester, fruit acid ester of fatty acids, propylene glycol ester and egg yolk.

A typical way of producing the confection mix is to incorporate the solid ingredients into the hot liquid ingredients at a temperature of about 50° C. to 70° C. The preparation is then pasteurized appropriately to reduce pathogenic microorganisms and homogenized to reduce the fat particle size and to produce a homogeneous mix. After these process steps, the mixture is cooled to some degrees above the freezing point and stored at that temperature for several hours (maturation time). Then the mixture is ready to be foamed and frozen. The final product is filled into its package and chilled or hardened [Arbuckle, W. S., in: ‘Ice Cream’; AVI-Van Nostrand Company Inc., New York, 1986, p.201-214].

One of the major roles of an emulsifier typically used in frozen, fat-containing confectionery is to displace some of the protein from the interface between the fat and the aqueous phase of the processed mixture. This takes place during the maturation time [Keeney, P. G. in: The ice cream review, 42, 1958, p. 26-45]. Fat particles, without their protective protein coat, are more sensitive to agglomerate and will form fat particle clusters during further processing, e.g., whipping or freezing. These fat particle clusters will form a fat network around the gas bubbles and throughout the continuous phase and thereby stabilize the structure and stability of the final, foamed product. Furthermore, it was shown that fat-soluble emulsifiers can help to speed-up the fat crystallization during the maturation time [Barfod, N. M.; Krog, N. and Buchheim, W. in: Fat Science and Technology, Nr.:1, 1991, p. 24-29].

Emulsifier molecules are used for their activity at the interface between the emulsified fat and the aqueous phase. It is known that many emulsifiers increase their functionality—which is to lower the interfacial tension between the fat and the aqueous phase—at lower temperatures. Several emulsifiers show a sudden, drastic increase in their functionality, in additional to the inverse temperature functionality, that is a sudden drop in the interfacial tension down to values of about 1/10 of their previous interfacial tension values, at a specific temperature, which depends on the type and concentration of the emulsifier. The temperature at that drastic change in interfacial tension is referred to as the “break temperature” in the literature. As an example, mono- and diacyl propylen-glycol and glycerols show, at temperatures below their specific “break temperature”, a drastically lower interfacial tension (Lutton, E. S. and Stauffer, C. E. and Martion, J. B. and Fehl, A. J. in: Journal of Colloid and Interfacial Science, Vol. 30, No. 3, July 1969).

Since the mixture maturation usually takes several hours, it is one of the longest process steps in the production of ice cream or related products. There is thus a need to find a way to allow a higher flexibility of ice cream mix maturation, including a reduced maturation time, while retaining or improving the stability and the texture of the finished, foamed product.

### SUMMARY OF THE INVENTION

The invention relates to a process for the preparation of a fat-containing, foamed, frozen confection. The process includes providing a confection mixture that includes at least a fat and an emulsifier, pasteurizing and homogenizing the mixture at a first temperature for a time sufficient to form a homogenized mixture, cooling the homogenized mixture, and freezing the cooled mixture. The cooling includes initially cooling the homogenized mixture from the homogenization temperature to about 10° C. to 35° C. for a first holding time sufficient to enhance emulsifier functionality and reduce maturation time, further cooling the homogenized mixture from about 10° C. to 35° C. down to about 1° C. to 10° C., and maintaining the temperature at about 1° C. to 10° C. for a second holding time of at least about 0.1 hour to form a cooled mixture. The process also includes freezing the cooled mixture while incorporating a gas into the mixture prior to or simultaneously with the freezing to form a foamed, frozen confection.

In one embodiment, the fat is a vegetable fat and the frozen confection further comprises one or more ingedients of milk derivatives, sugars or other sweeteners, water, flavorings, and stabilizers, wherein the ingredients are mixed with the fat and emulsifier to form the confection mixture. The emulsifier exhibits a break in the correlation of interfacial tension between oil and water at concentrations of 0.01% to 5% and over temperatures of about 20° C. to 40° C. and includes one or more of mono- and diacyl glycerides of fatty acids, or a propylene glycol ester. Preferably, the emulsider is present in an amount of about 0.01% to 0.5% by weight of the confection mixture.

The homogenization temperature is sufficient to form an emulsion of the confection mixture, preferably at least about 80° C. The initial and further coolings occurs during a period of ten minutes or less for each. The incorporated gas may be air and be incorporated in an amount sufficient to form a frozen confection having 20% to 200% air by volume. Preferably, the first holding time is about 5 to 30 minutes and the second holding time is about 0.1 to 4 hours.

### DETAILED DESCRIPTION OF THE INVENTION

The invention relates to a process for the preparation of a fat-containing, foamed, frozen confection. The process includes: mixing together the ingredients of the ice confection, pasteurizing and homogenizing the mixture to form a homogenized mixture, cooling the homogenized mixture in at least two steps, in the first step the temperature is decreased from the pasteurization or homogenization temperature to about 10° C. to 35° C., and in the second step the temperature is decreased from about 10° C. to 35° C. to about 1° C. to 10° C. Between the cooling steps, a holding time is applied wherein the temperature of the mixture is maintained between 10° C. and 35° C. The cooled mixture is then maintained at the temperature of about 1° C. to 10° C. for at least 0.1 hour and air or another gas is incorporated into the cooled mixture prior to or concurrently with a final freezing.

The important element in the process according to the invention is a holding time of the ice cream mixture at an intermediate temperature prior to the mixture maturation. A holding time is required between the first and the second cooling steps. This holding time at an intermediate temperature enhances the functionality of the emulsifiers and thereby allows a shorter maturation (or aging) time. The normal process procedure is to have a two-step cooling treatment but, it is also possible to have a three-step cooling or another cooling profile.

For the production of an ice confection the ingredients used are milk derivatives, sugars, other sweeteners, vegetable fats, water, flavorings, stabilizers, and emulsifiers. The milk derivatives are the main protein source and can be plain milk, cream, skimmed milk powder, or whey-protein powder. For the production of ice cream, the skimmed milk powder and sometimes whey-protein powder are the standard sources of protein.

As used herein, a “frozen confection” refers to ice cream, ice desserts like iced milk or frozen yogurt or similar foamed, frozen products, which contain water, air or another gas, fat, carbohydrates, and proteins, and may contain other ingredients.

Only vegetable fats are mentioned, because the dairy fats are already mentioned in the milk derivatives. As source of vegetable fat, palm, palm kernel, coconut, and other fats may be used. The flavorings may include any type of flavorings depending on the final desired product. For example, it is possible to use vanilla, chocolate, and every type of fruit flavoring. The stabilizer may include one or more of gelatin or polysaccharides such as carrageenan, sodium alginate, sodium carboxymethylcellulose, guar gum, locust bean gum, and pectin.

The fat-containing, foamed confectionery product of this invention contains fat in an amount of about 1% to about 20%, preferably 3% to 18%. This fat has a solid fat content of about 60% to 85%, preferably 65% to 80%, at 5° C.

Furthermore, the invention contains non-fat milk solids or other sources of protein in an amount of about 1% to about 15%, preferably 8% to 15% (referred to as milk solids with about 35% protein), sugar in an amount of about 0% to 18%, preferably 8% to 15%, other oligo- or polysaccharides in an amount of 0% to 12%, preferably 5% to 10%, emulsifier in an amount of 0.01 to about 3%, preferably 0.05% to 0.5%, and stabilizer in an amount of about 0.05 to 1%, preferably 0.1% to 0.5%. The total solids of the mixture of ingredients is about 10% to 60%, preferably 20% to 40%. All percentages are by weight and relative to the total weight of the mixture.

The sugar includes normally the lactose naturally present in milk products, but also sucrose, maltose, dextrose, fructose, glucose. Other sweeteners, such as artificial sweeteners, may also be used in the confection.

The important element in the process according to the invention is to use a two step cooling, and more particularly to apply between the first and the second cooling steps, a holding time. This holding time enhances the functionality of the emulsifiers, and thereby allows a shorter maturation (or aging) time and a higher final quality.

For the process of the invention, not every type of emulsifier can be used. Only small-molecule surfactants are used. These compounds are distinct from other emulsifying molecules, such as proteins. The emulsifiers used in the process of the invention include one or more of mono- and diacyl glycerides of fatty acids, propylene glycol ester, and another emulsifier showing a break in the correlation of interfacial tension between oil and water at concentrations of 0.01% to 5% and over temperatures of about 20° C. to 40° C. They are present in the ice confection mixture in the amount of 0.01% to 5% based on the final composition. The concentration of the emulsifier is preferably 0.01% to 0.5%. Other small-molecule emulsifiers, which do not meet the above-mentioned characteristics of the break temperature can be used additionally with the basic emulsifier. In the present specification, all the percentages are given in weight. The water content of the ice confection is normally 45% to 65%.

The different ingredients of the ice confection are mixed together: first all fluid, then the solid ingredients are blended together at elevated temperature to enable the dissolution and coarse emulsification of the ingredients.

The ice confection mix is treated for microbiological reasons. This is done either before or after the homogenization step. The pasteurization of the mixture is usually carried out in a plate heat exchanger at temperatures of about 80° C. for 20 to 30 seconds, or at 105° C. to 130° C. for 1 to 2 seconds. An efficient homogenization must be carried out at a temperature where the fat phase is completely liquid, preferably near the pasteurization temperature. During homogenization, the ice confection mixture is converted into a true emulsion.

Immediately after the homogenization and pasteurization treatment, the confection mixture is submitted to the two-step cooling treatment. The first step corresponds to a temperature decrease from the pasteurization or homogenization temperature to around 10° C. to 35° C. The time necessary to cool to this intermediate temperature is not critical for this invention. A faster cooling is preferred, however, for microbiological and process reasons. The decrease of the temperature is carried out in 10 minutes or less, and preferably in 5 minutes or less. The temperature after the first cooling step has to be about 5° C. to 10° C. below the characteristic “break temperature” of the selected emulsifier. The “break temperature” depends on the type and concentration of the selected emulsifier. As an example, for glycerol-monostearate at a concentration of 0.1%, the break temperature is 30° C. (Lutton, E. S. et al 1969; and Groh, B. F. Fortschritts-Berichte VDI, Reihe 3, Nr. 553, page 112, 1998). The characteristic “break temperatures”, of several emulsifiers at various concentrations can be found in Lutton et. al 1969.

The important feature for the process of the invention is the holding time between the first and the second cooling step. A holding time of about 5 to 30 minutes, preferably 10 to 20 minutes is applied, because it enhances the functionality of the emulsifiers, which speed up the necessary processes during the maturation time and thereby allow for a shorter maturation time.

During the second cooling step, the temperature of the ice confection mixture is further decreased from 10° C. to 35° C. down to the maturation temperature of about 1° C. to 10° C. The temperature is decreased by about 9 to 34° C. and preferably by about 21° C. in this step. As for the first cooling step, this cooling time is not critical for the invention. A faster cooling is preferred for microbiological and process reasons. The cooling is carried out in 10 minutes or less, preferably in 5 minutes or less. The processed confection mixture is then maintained at the maturation temperature for a period of at least about 0.1 to 24 hours, and preferably for about 0.5 to 4 hours.

After the maturation time, the processed confection mixture is whipped. Gas is incorporated into the mixture which may be further cooled to a temperature of about −3.5° C. to −7° C., which results in a soft, pasty-like consistency (for high temperatures) or a stiff, shape-retaining consistency (for low temperatures). During a continuous freezing process, if applied, rotating knives continuously scrape ice forming from the cooled mixture off the inner wall of a tube and help to incorporate the air or other gas. The air or other gas incorporation may also occur before the freezing. Whipping and freezing permit volume of air in the frozen confection to be 10% to 200%, preferably 20% to 120%, by volume of the whole composition. After whipping and freezing, the freshly produced confection has a stiff, pastry-like consistency and can be filled in different forms such as cups, cones, or molds for sticks, or in bulk containers.

The confection is then frozen: it is hardened as quickly as possible to reach a final temperature around −20° C. The ice confection can then be stored at −20° C. to −35° C. for the normal shelf-life of ice confection products.

According to analysis made on the product of the invention, the median air bubble size in the samples are slightly smaller than the reference samples, that is, the samples produced through a normal procedure with a maturation time of 4 hours. The samples have a relatively high microstructural stability when produced with a maturation time of one hour and a holding time of 15 minutes.

The process following this invention offers several benefits compared to traditional processes with the longer maturation times. The process of the present invention requires smaller capacity of the maturation tanks thereby reducing the capital investment for the tanks and requires less space in the production area. The process is faster and therefore a less expensive process. The present invention offers a higher operational flexibility and allows a faster response to unforeseen or changed mixture production (important for seasonal products like ice cream). The confectionery products referred to in this invention, often contain fresh ingredients, such as milk, cream, or fresh flavoring ingredients. The ingredients can be processed faster and will result therefore in fresher final products. With a significantly reduced maturation time this invention offers the same or very similar handling characteristics (whipping or freezing behavior of the processed and cooled mix) as compared to the traditional process with several hours of maturation. Furthermore, it offers the same or very similar filling/packaging characteristics and the same or a very similar final quality (texture and stability) compared to traditionally produced products.

### EXAMPLE

The invention is further explained by referring to the following example describing in detail the method of the present invention. This example is representative and should not be construed to limit the scope of the invention in any way.

The following recipe was used to prepare an ice-cream mix

| | |
|---|---|
| Skimmed milk powder (with 33% protein) | 10% |
| Sucrose | 15% |
| Glucose | 5% |
| Fat, hydrogenated (60% coconut/40% palm | 10% |
| kernel) | |
| Na-alginate (as stabilizer) | 0.3% |
| Monodiglyceride (as emulsifier with a Glycerol- | 0.2% |
| monostearate content of >90%) | |
| Water (65° C.) | 59.5% |

In preparation of the blending, the stabilizer was mixed with the sugar and the emulsifier dissolved in the liquid fat (60° C.). All the powders and then the fat phase were added, while stirring, to the hot water. The mixture was then pasteurized at a temperature of 87° C., for 30 seconds. After that the mixture was homogenized at a temperature of 77° C. in a two stage homogenizer. The mixture was cooled in a plate-heat exchanger down to 25° C. and this temperature was maintained for 15 minutes. Finally, the mixture was cooled with a plate heat exchanger to a temperature of 4° C. and maintained at this temperature for a maturation of one hour. After the maturation time, the ice cream was frozen in a continuous ice cream freezer to a draw temperature of −5° C. with an air incorporation to achieve 80% overrun. The ice cream was filled in cups and hardened at −30° C. for six hours.

The resulting product was compared to a product produced from the same ingredients with the same process, except for a single step cooling step before a maturation time of 24 hours. No significant differences were found comparing these two products, fresh and after a heat shock treatment for their melting behavior, their fat particle profile and their sensorial impression.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A process for the preparation of a fat-containing, foamed, frozen confection, which comprises:
providing a confection mixture that includes at least a fat and an emulsifier;
pasteurizing and homogenizing the mixture at a first temperature for a time sufficient to form a homogenized mixture;
initially cooling the homogenized mixture from the homogenization temperature to about 10° C. to 35° C.; maintaining the temperature at about 10° C. to 35° C. for a first holding time sufficient to enhance emulsifier functionality and reduce maturation time; further cooling the homogenized mixture from about 10° C. to 35° C. down to about 1° C. to 10° C.; maintaining the temperature at about 1° C. to 10° C. for a second holding time of at least about 0.1 hour to form a cooled mixture; and
freezing the cooled mixture while incorporating a gas into the mixture prior to or simultaneously with the freezing to form a foamed frozen confection.

2. The process of claim 1, wherein the fat is a vegetable fat and the frozen confection further comprises one or more ingredients of milk derivatives, sugars or other sweeteners, water, flavorings, and stabilizers; wherein the ingredients are mixed with the fat and emulsifier to form the confection mixture.

3. The process of claim 1, wherein the emulsifier exhibits a break in the correlation of interfacial tension between oil and water at concentrations of 0.01% to 5% and over temperatures of about 20° C. to 40° C.

4. The process of claim 3, wherein the emulsifier comprises one or more of mono- and diacyl glycerides of fatty acids, or a propylene glycol ester.

5. The process of claim 4, wherein the emulsifier is present in an amount of about 0.01% to 0.5% by weight of the confection mixture.

6. The process of claim 1, wherein the homogenization temperature is sufficient to form an emulsion of the confection mixture.

7. The process of claim 1, wherein the homogenization temperature is at least about 80° C.

8. The process of claim 1, wherein the initial cooling occurs during a time period of 10 minutes or less.

9. The process of claim 1, wherein the further cooling occurs during a time period of 10 minutes or less.

10. The process of claim 1, wherein the gas is air and sufficient air is incorporated into the cooled mixture to form a frozen confection having 20% to 200% air by volume.

11. The process of claim 1, wherein the first holding time is about 5 to 30 minutes.

12. The process of claim 1, wherein the second holding time is about 0.1 to 4 hours.

13. A process for the preparation of a fat-containing, foamed, frozen confection, which comprises:
providing a confection mixture that includes a fat, an emulsifier, a milk derivative, a sugar or other sweetener, water, a flavoring, and a stabilizer;
pasteurizing and homogenizing the mixture at a first temperature of at least about 80° C. for a time sufficient to form a homogenized mixture wherein the confection is in the form of a emulsion;
initially cooling the homogenized mixture from the homogenization temperature to about 10° C. to 35° C. in 10 minutes or less; maintaining the temperature at about 10° C. to 35° C. for a first holding time of between about 5 and 30 minutes to enhance emulsifier functionality and reduce maturation time; further cooling the homogenized mixture from about 10° C. to 35° C. down to about 1° C. to 10° C. in 10 minutes or less; maintaining the temperature at about 1 ° C. to 10° C. for a second holding time of about 0.1 to 4 hours to form a cooled mixture; and
freezing the cooled mixture while incorporating a gas into the mixture prior to or simultaneously with the freezing to form a foamed frozen confection having 20% to 200% gas by volume.

14. The process of claim 13, wherein the emulsifier exhibits a break in the correlation of interfacial tension between oil and water at concentrations of 0.01% to 5% and over temperatures of about 20° C. to 40° C.

15. The process of claim 14 wherein the emulsifier comprises one or more of mono- and diacyl glycerides of fatty acids, or a propylene glycol ester.

16. The process of claim 15, wherein the emulsifier is present in an amount of about 0.01% to 0.5% by weight of the confection mixture.
